(19) United States
(12) Patent Application Publication
(10) Pub. No.: US 2013/0318998 A1
(43) Pub. Date: Dec. 5, 2013

(54) GEARED TURBOFAN WITH THREE TURBINES WITH HIGH SPEED FAN DRIVE TURBINE

(71) Applicants: Frederick M. Schwarz, Glastonbury, CT (US); Daniel Bernard Kupratis, Wallingford, CT (US)

(72) Inventors: Frederick M. Schwarz, Glastonbury, CT (US); Daniel Bernard Kupratis, Wallingford, CT (US)

(21) Appl. No.: 13/484,589

(22) Filed: May 31, 2012

(51) Int. Cl. F02C 3/06

(52) U.S. Cl. 60/792

(57) ABSTRACT

A gas turbine engine has a fan rotor, a first compressor rotor and a second compressor rotor and three turbine sections. A fan drive drives the fan through a gear reduction. The fan drive turbine section has a first exit area at a first exit point and is configured to rotate at a first speed. A second turbine section has a second exit area at a second exit point and is configured to rotate at a second speed that is faster than the first speed. A first performance quantity is defined as the product of the first speed squared and the first area. A second performance quantity is defined as the product of the second speed squared and the second area. A ratio of the first performance quantity to the second performance quantity is between about 0.5 and about 1.5.

### BACKGROUND

This application relates to a gas turbine having three turbine sections, with one of the turbine sections driving a fan through a gear change mechanism.

Gas turbine engines are known, and typically include a compressor section compressing air and delivering the compressed air into a combustion section. The air is mixed with fuel and combusted, and the product of that combustion passes downstream over turbine rotors.

In one known gas turbine engine architecture, there are two compressor rotors in the compressor section, and three turbine rotors in the turbine section. A highest pressure turbine rotates a highest pressure compressor. An intermediate pressure turbine rotates a lower pressure compressor, and a third turbine is a fan drive turbine which drives the fan.

### SUMMARY

In a featured embodiment, a gas turbine engine has a fan rotor, a first compressor rotor and a second compressor rotor, the second compressor rotor for compressing air to a higher pressure than the first compressor rotor. A first turbine rotor drives the second compressor rotor, and a second turbine rotor drives the first compressor rotor. A fan drive turbine is positioned downstream of the second turbine rotor to drive the fan rotor through a gear reduction. The first compressor rotor and second turbine rotor are configured to rotate as an intermediate speed spool. The second compressor rotor and first turbine rotor are configured to rotate together as a high speed spool, with the high speed spool, intermediate speed spool, and fan drive turbine configured to rotate in the same first direction. The fan drive turbine section has a first exit area at a first exit point and is configured to rotate at a first speed. The second turbine section has a second exit area at a second exit point and is configured to rotate at a second speed, which is faster than the first speed. A first performance quantity is defined as the product of the first speed squared and the first area. A second performance quantity is defined as the product of the second speed squared and the second area. A ratio of the first performance quantity to the second performance quantity is between about 0.5 and about 1.5.

In another embodiment according to the previous embodiment, the fan rotor is driven by the gear reduction to rotate in the first direction.

In another embodiment according to any of the previous embodiments, the ratio is above or equal to about 0.8.

In another embodiment according to any of the previous embodiments, the fan drive turbine section has at least three stages.

In another embodiment according to any of the previous embodiments, a pressure ratio across the fan drive turbine section is greater than about 5:1.

In another embodiment according to any of the previous embodiments, a bypass ratio is defined for the fan, as a ratio of the amount of air delivered into a bypass path divided by the amount of air delivered to the first compressor rotor. The bypass ratio is greater than about 6.

In another embodiment according to any of the previous embodiments, the bypass ratio is greater than about 10.

In another embodiment according to any of the previous embodiments, a gear reduction ratio of the speed reduction is greater than about 2.3.

In another embodiment according to any of the previous embodiments, the first turbine rotor has one or two stages.

In another embodiment according to any of the previous embodiments, the fan drive turbine section has between two and six stages.

In another embodiment according to any of the previous embodiments, a low fan pressure ratio is defined as the ratio of total pressure across the fan blade alone, before any fan exit guide vanes, and the low fan pressure ratio is less than about 1.45.

In another featured embodiment, a gas turbine engine has a fan rotor, a first compressor rotor and a second compressor rotor. The second compressor rotor is for compressing air to a higher pressure than the first compressor rotor. A first turbine rotor drives the second compressor rotor, and a second turbine rotor drives the first compressor rotor. A fan drive turbine is positioned downstream of the second turbine rotor. The fan drive turbine drives the fan rotor through a gear reduction. The first compressor rotor and the second turbine rotor rotate as an intermediate speed spool. the second compressor rotor and first turbine rotor rotate together as a high speed spool. The high speed spool, intermediate speed spool, and fan drive turbine are configured to rotate in the same direction. The fan rotor is driven by the speed reduction to rotate in the first direction. The fan drive turbine section has a first exit area at a first exit point and is configured to rotate at a first speed. The second turbine section has a second exit area at a second exit point and is configured to rotate at a second speed, which is faster than the first speed. A first performance quantity is defined as the product of the first speed squared and the first area. A second performance quantity is defined as the product of the second speed squared and the second area. A ratio of the first performance quantity to the second performance quantity is between about 0.8 and about 1.5.

In another embodiment according to any of the previous embodiments, the fan drive turbine section has at least three stages.

In another embodiment according to any of the previous embodiments, a pressure ratio across the fan drive turbine section is greater than about 5:1.

In another embodiment according to any of the previous embodiments, a bypass ratio is defined for the fan, as a ratio of the amount of air delivered into a bypass path divided by the amount of air delivered to the first compressor rotor. The bypass ratio is greater than about 6.

In another embodiment according to any of the previous embodiments, the bypass ratio is greater than about 10.

In another embodiment according to any of the previous embodiments, a gear reduction ratio of the speed reduction is greater than about 2.3.

In another embodiment according to any of the previous embodiments, the first turbine rotor has one or two stages.

In another embodiment according to any of the previous embodiments, the fan drive turbine section has between two and six stages.

In another embodiment according to any of the previous embodiments, a low fan pressure ratio is defined as the ratio of total pressure across the fan blade alone, before any fan exit guide vanes. The low fan pressure ratio is less than about 1.45.

These and other features of the invention would be better understood from the following specifications and drawings, the following of which is a brief description.

### BRIEF DESCRIPTION OF THE DRAWINGS

FIG. 1 schematically shows a gas turbine engine.

FIG. 2 shows exit areas in a schematic engine.

### DETAILED DESCRIPTION

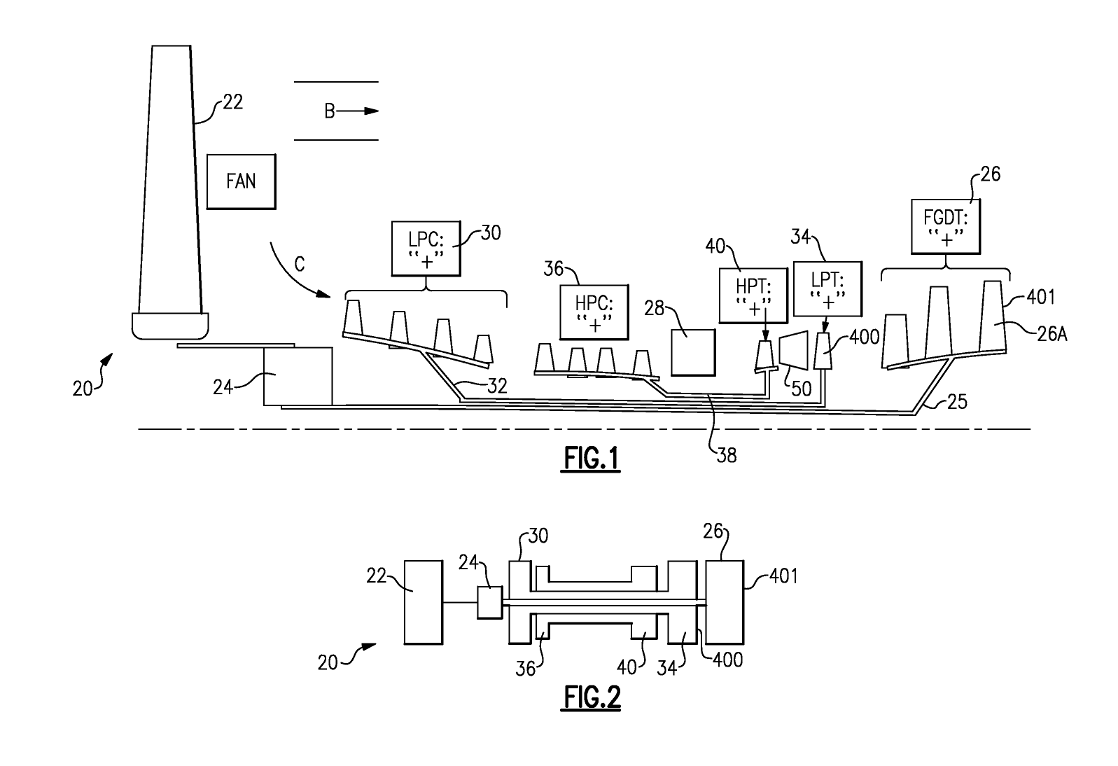

A gas turbine engine 20 is illustrated in FIG. 1, and incorporates a fan 22 driven through a gear reduction 24. The gear reduction 24 is driven with a low speed spool 25 by a fan/gear drive turbine (“FGDT”) 26. Air is delivered from the fan as bypass air B, and into a low pressure compressor 30 as core air C. The air compressed by the low pressure compressor 30 passes downstream into a high pressure compressor 36, and then into a combustion section 28. From the combustion section 28, gases pass across a high pressure turbine 40, low pressure turbine 34, and fan drive turbine 26.

A plurality of vanes and stators 50 may be mounted between the several turbine sections. In particular, as shown, the low pressure compressor 30 rotates with an intermediate pressure spool 32 and the low pressure turbine 34 in a first (“+”) direction. The fan drive turbine 26 rotates with a shaft 25 in the same (“+”) direction as the low pressure spool 32. The speed change gear 24 may cause the fan 22 to rotate in the first (“+”) direction. However, the fan rotating in the opposed direction (the second direction) would come within the scope of this invention. As is known within the art, a star gear arrangement may be utilized for the fan to rotate in an opposite direction as to the fan/gear drive turbine 26. On the other hand, a planetary gear arrangement may be utilized, wherein the two rotate in the same direction. The high pressure compressor 36 rotates with a spool 38 and is driven by a high pressure turbine 40 in the first direction (“+”).

Since the turbines 26, 34 and 40 are rotating in the same direction, a first type of vane 50 is incorporated between these three sections. Vane 50 may be a highly cambered vane, and may be used in combination with a mid-turbine frame. The vane 50 may be incorporated into a mid-turbine frame as an air turning mid-turbine frame (“TMTF”) vane.

The fan drive turbine 26 in this arrangement can operate at a higher speed than other fan drive turbine arrangements. The fan drive turbine can have shrouded blades, which provides design freedom.

The low pressure compressor may have more than three stages. The fan drive turbine has at least two, and up to six stages. The high pressure turbine as illustrated may have one or two stages, and the low pressure turbine may have one or two stages.

An exit area 400 is shown, in FIGS. 1 and 2, at the exit location for the low pressure turbine section 34 is the annular area of the last blade of turbine section 34. An exit area for the fan drive turbine section 26 is defined at exit 401, and is the annular area defined by the last blade of that turbine section 26. With this arrangement, and with the other structure as set forth above, including the various quantities and operational ranges, a very high speed can be provided to the low pressure spool. Turbine section operation is often evaluated looking at a performance quantity, which is the exit area for the turbine section multiplied by its respective speed squared. This performance quantity (“PQ”) is defined as:

PQ_{fdt}=(A_{fdt}×V_{fdt}²) Equation 1

PQₗₚₜ=(Aₗₚₜ×Vₗₚₜ²) Equation 2

where A_{fdt} is the area of the fan drive turbine section at the exit thereof (e.g., at 401), where V_{fdt} is the speed of the fan drive turbine section, where Aₗₚₜ is the area of the low pressure turbine section at the exit thereof (e.g., at 400), and where Vₗₚₜ is the speed of the low pressure turbine section.

Thus, a ratio of the performance quantity for the fan drive turbine section compared to the performance quantify for the low pressure turbine section is:

(A_{fdt}×V_{fdt}²)/(Aₗₚₜ×Vₗₚₜ²)=PQ_{fdt/}PQₗₚₜ Equation 3

In one turbine embodiment made according to the above design, the areas of the fan drive and low pressure turbine sections are 557.9 in² and 90.67 in², respectively. Further, the speeds of the fan drive and low pressure turbine sections are 10179 rpm and 24346 rpm, respectively. Thus, using Equations 1 and 2 above, the performance quantities for the fan drive and low pressure turbine sections are:

PQ_{fdt}=(A_{fdt}×V_{fdt}²)=(557.9 in²)(10179 rpm)²=57805157673.9 in² rpm² Equation 1

PQₕₚₜ=(Aₗₚₜ×Vₗₚₜ²)=(90.67 in²)(24346 rpm)²=53742622009.72 in² rpm² Equation 2

and using Equation 3 above, the ratio for the low pressure turbine section to the high pressure turbine section is:

Ratio=PQ_{fdt/}PQₗₚₜ=57805157673.9 in² rpm²/53742622009.72 in² rpm²=1.075

In another embodiment, the ratio was about 0.5 and in another embodiment the ratio was about 1.5. With PQ_{fdt/}PQₗₚₜ ratios in the 0.5 to 1.5 range, a very efficient overall gas turbine engine is achieved. More narrowly, PQ_{fdt/}PQₗₚₜ ratios of above or equal to about 0.8 are more efficient. Even more narrowly, PQ_{fdt/}PQₗₚₜ ratios above or equal to 1.0 are even more efficient. As a result of these PQ_{fdt/}PQₗₚₜ ratios, in particular, the turbine section can be made much smaller than in the prior art, both in diameter and axial length. In addition, the efficiency of the overall engine is greatly increased.

The engine 20 is a high-bypass geared aircraft engine. The bypass ratio is the amount of air delivered into bypass path B divided by the amount of air into core path C. In a further example, the engine 20 bypass ratio is greater than about six (6), with an example embodiment being greater than ten (10), the geared architecture 24 is an epicyclic gear train, such as a planetary gear system or other gear system, with a gear reduction ratio of greater than about 2.3 and the fan/gear drive turbine section 26 has a pressure ratio that is greater than about 5. In one disclosed embodiment, the engine 20 bypass ratio is greater than about ten (10:1), the fan diameter is significantly larger than that of the low pressure compressor section 30, and the fan/gear drive turbine section 26 has a pressure ratio that is greater than about 5:1. In some embodiments, the high pressure turbine section 40 may have two or fewer stages. In contrast, the fan/gear drive turbine section 26, in some embodiments, has between two and six stages. Further the fan/gear drive turbine section 26 pressure ratio is total pressure measured prior to inlet of fan/gear drive turbine section 26 as related to the total pressure at the outlet of the fan/gear drive turbine section 26 prior to an exhaust nozzle. The geared architecture 24 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (“TSFC”). TSFC is the industry standard parameter of the rate of 1 bm of fuel being burned per hour divided by 1 bf of thrust the engine produces at that flight condition. “Low fan pressure ratio” is the ratio of total pressure across the fan blade alone, before the fan exit guide vanes. The low fan pressure ratio as disclosed herein according to one non-limiting embodiment is less than about 1.45. “Low corrected fan tip speed” is the actual fan tip speed in ft/sec divided by an industry standard temperature correction of [(Ram Air Temperature deg R)/518.7)̂0.5]. The “Low corrected fan tip speed” as disclosed herein according to one non-limiting embodiment is less than about 1150 ft/second. Further, the fan 22 may have 26 or fewer blades.

Engines made with the disclosed architecture, and including turbine sections as set forth in this application, and with modifications coming from the scope of the claims in this application, thus provide very high efficient operation, and increased fuel efficiency and lightweight relative to their trust capability.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A gas turbine engine comprising:
a fan rotor, a first compressor rotor and a second compressor rotor, said second compressor rotor for compressing air to a higher pressure than said first compressor rotor;
a first turbine rotor, said first turbine rotor configured to drive said second compressor rotor, and a second turbine rotor, said second turbine configured to drive said first compressor rotor;
a fan drive turbine positioned downstream of said second turbine rotor, said fan drive turbine for driving said fan rotor through a gear reduction;
said first compressor rotor and said second turbine rotor configured to rotate as an intermediate speed spool, and said second compressor rotor and said first turbine rotor configured to rotate together as a high speed spool, with said high speed spool, said intermediate speed spool, and said fan drive turbine configured to rotate in the same first direction;
wherein said fan drive turbine section has a first exit area at a first exit point and is configured to rotate at a first speed, said second turbine section has a second exit area at a second exit point and is configured to rotate at a second speed, which is faster than the first speed; and
a first performance quantity is defined as the product of the first speed squared and the first area, a second performance quantity is defined as the product of the second speed squared and the second area, and a ratio of the first performance quantity to the second performance quantity is between about 0.5 and about 1.5.

2. The engine as set forth in claim 1, wherein said fan rotor is driven by said gear reduction to rotate in said first direction.

3. The engine as set forth in claim 1, wherein said ratio is above or equal to about 0.8.

4. The engine as set forth in claim 1, wherein said fan drive turbine section has at least three stages.

5. The engine as set forth in claim 1, wherein a pressure ratio across the fan drive turbine section is greater than about 5:1.

6. The engine as set forth in claim 1, wherein a bypass ratio is defined for said fan, as a ratio of the amount of air delivered into a bypass path divided by the amount of air delivered to said first compressor rotor, and said bypass ratio being greater than about 6.

7. The engine as set forth in claim 6, wherein said bypass ratio is greater than about 10.

8. The engine as set forth in claim 1, wherein a gear reduction ratio of the speed reduction is greater than about 2.3.

9. The engine as set forth in claim 1, wherein said first turbine rotor has one or two stages.

10. The engine as set forth in claim 1, wherein said fan drive turbine section has between two and six stages.

11. The engine as set forth in claim 1, wherein a low fan pressure ratio is defined as the ratio of total pressure across the fan blade alone, before any fan exit guide vanes, and said low fan pressure ratio is less than about 1.45.

12. A gas turbine engine comprising:
a fan rotor, a first compressor rotor and a second compressor rotor, said second compressor rotor for compressing air to a higher pressure than said first compressor rotor;
a first turbine rotor, said first turbine rotor configured to drive said second compressor rotor, and a second turbine rotor, said second turbine configured to drive said first compressor rotor;
a fan drive turbine positioned downstream of said second turbine rotor, said fan drive turbine configured to drive said fan rotor through a gear reduction;
said first compressor rotor and said second turbine rotor rotating as an intermediate speed spool, said second compressor rotor and said first turbine rotor rotating together as a high speed spool, with said high speed spool, said intermediate speed spool, and said fan drive turbine configured to rotate in the same direction;
said fan rotor being driven by said speed reduction to rotate in said first direction;
wherein said fan drive turbine section has a first exit area at a first exit point and is configured to rotate at a first speed, said second turbine section has a second exit area at a second exit point and is configured to rotate at a second speed, which is faster than the first speed; and
a first performance quantity is defined as the product of the first speed squared and the first area, a second performance quantity is defined as the product of the second speed squared and the second area, and a ratio of the first performance quantity to the second performance quantity is between about 0.8 and about 1.5.

13. The engine as set forth in claim 12, wherein said fan drive turbine section has at least three stages.

14. The engine as set forth in claim 12, wherein a pressure ratio across the fan drive turbine section is greater than about 5:1.

15. The engine as set forth in claim 12, wherein a bypass ratio is defined for said fan, as a ratio of the amount of air delivered into a bypass path divided by the amount of air delivered to said first compressor rotor, and said bypass ratio being greater than about 6.

16. The engine as set forth in claim 15, wherein said bypass ratio is greater than about 10.

17. The engine as set forth in claim 12, wherein a gear reduction ratio of the speed reduction is greater than about 2.3.

18. The engine as set forth in claim 12, wherein said first turbine rotor has one or two stages.

19. The engine as set forth in claim 12, wherein said fan drive turbine section has between two and six stages.

20. The engine as set forth in claim 12, wherein a low fan pressure ratio is defined as the ratio of total pressure across the fan blade alone, before any fan exit guide vanes, and said low fan pressure ratio is less than about 1.45.
